(19) United States
(12) Patent Application Publication
(10) Pub. No.: US 2012/0272795 A1
(43) Pub. Date: Nov. 1, 2012

(54) Hand Tool

(76) Inventor: Tsai-Ching Chen, Fu Hsing Shiang (TW)

(21) Appl. No.: 13/541,803

(22) Filed: Jul. 5, 2012

Related U.S. Application Data
(63) Continuation-in-part of application No. 12/714,748, filed on Mar. 1, 2010.

(30) Foreign Application Priority Data
Jul. 27, 2009 (TW) 98125221

(51) Int. Cl. B25B 23/00

(52) U.S. Cl. 81/177.75

(57) ABSTRACT

A hand tool comprises a shaft including a first coupled portion, a double-ended joint including a second coupled portion coupled to the first coupled portion and a third coupled portion. The double-ended joint is pivotable with respect to the shaft between a first position they are coaxial and a second position they have various relative tilting positions. An interconnecting member includes a fourth coupled portion coupled to the third coupled portion and a mounted portion. The interconnecting member is pivotable with respect to the double-ended joint between a first position they are coaxial and a second position they have various relative tilting positions.

### CROSS REFERENCE

The present application is a continuation-in-part application of U.S. patent application Ser. No. 12/714,748, filed on Mar. 1, 2010, of which the entire disclosure is incorporated herein.

### BACKGROUND OF THE INVENTION

1. Field of the Invention

The present invention relates to a hand tool and, more particularly, to a hand tool which can be bent to form various shapes that a user can use it in a tiny space easily.

2. Description of the Related Art

Referring to Taiwan Patent No. M305735, it discloses that a chuck includes a shaft having a hole and a magnetic element and a sleeve mounted on the shaft. The hole of the shaft is adapted to couple to a bit, and the magnetic element is engaged with an end of the sleeve. The shaft is slideably disposed in another end of the sleeve between first and second positions that the bit can be released/installed from/to the shaft quickly.

The chuck is adapted to couple to the bit which is connected to a bolt or a driven means. A center axis of the bit and a center axis of the chuck are co-linear. However, the conventional chuck can not be bent to form various shapes and insert into a tiny space with angles neither. For example, an engine room of a vehicle where most of bolts and fasteners are disposed inside the engine room would be hided by the other components and cannot be easily to be driven by the conventional hand tool (like the above chuck).

Moreover, in order to drive bolts hided inside an equipment, a cable-type joint is provided which can be bent to form various shapes for needs. The joint, which is defined at an end of the cable, is inserted into a gap between components of the equipment and engaged with the bolt, and then the cable is rotated to drive the joint to engage with/disengage from the bolt. The cable is easy to be bent; however, it cannot provide enough torque for firmly locking the bolt in a screw by the joint. Therefore, this kind of cable-type joint only applies to bolts with lightweight but not fasteners which are provided at heavy machine.

The present invention is, therefore, intended to obviate or at least alleviate the problems encountered in the prior art.

### SUMMARY OF THE INVENTION

According to the present invention, a hand tool includes a shaft, A double-ended joint, and an interconnecting member. The shaft includes a first coupled portion. A first central axis is defined through center points of all transverse cross-sections of the shaft. The double-ended joint includes a connecting portion, a second coupled portion on opposite sides of the connecting portion coupled to the first coupled portion and a third coupled portion respectively. The connecting portion is polygonal in cross section. The first coupled portion is polygonal in cross section. A second central axis is defined through center of all transverse cross-sections of the double-ended joint. The double-ended joint is pivotable with respect to the shaft between first and second positions. The first and second central axes are co-axial and the connecting portion is partially and correspondingly received in the first coupled portion when the double-ended joint is in the first position. The first and second central axes form a first bent angle and the connecting portion is disengaged from the first coupled portion when the double-ended joint is in the second position. The interconnecting member including a fourth coupled portion coupled to the third coupled portion and a mounted portion. A third central axis defined through center of all transverse cross-sections of the interconnecting member. The interconnecting member is pivotable with respect to the double-ended joint between first and second positions. The second and third central axes are co-axial and the connecting portion is partially and correspondingly received in the fourth coupled portion when the interconnecting member is in the first position. The connecting portion is disengaged from the fourth coupled portion when the interconnecting member is in the second position. The first and third central axes form a second bent angle when the double-ended joint and the interconnecting member are both in the second position.

One objective of the present invention is that the hand tool allows the bit which is coupled thereto to insert into a more tiny space in use.

Another objective of the present invention is that two ends of the double-ended joint are adapted to couple to the sliding sleeve and the shaft respectively and the sliding sleeve and the shaft can bent with respect to the double-ended joint respectively, so it provides the hand tool to have more kinds of angled shapes.

Other objectives, advantages, and features of the invention will become more apparent from the following detailed description when taken in conjunction with the accompanying drawings.

### BRIEF DESCRIPTION OF THE DRAWINGS

FIG. 1 is a perspective view of a hand tool in according to a first embodiment of the present invention.

FIG. 2 is an exploded perspective view of the hand tool of FIG. 1.

FIG. 3 is a cross-sectional view taken along line 3-3 in FIG. 1.

FIG. 4 is a cross-sectional view taken along line 4-4 in FIG. 1.

FIG. 5 is a cross-sectional view taken along line 5-5 in FIG. 3.

FIG. 6 is a cross-sectional view taken along line 6-6 in FIG. 3.

FIG. 7 is a cross-sectional view similar to FIG. 1, but illustrating the operation of the hand tool and which in a position including a sliding sleeve in different position.

FIG. 8 is a continued cross-sectional view of FIG. 7, but illustrating the hand tool in a position including a shaft, a double-ended joint, and an interconnecting member with the sliding sleeve in different relative positions.

FIG. 9 is a cross-section view illustrating the hand tool including the shaft, the double-ended joint, and the interconnecting member with the sliding sleeve in relative positions in which the shaft and the double-ended joint are able to pivot relative to one another and the double-ended joint and the interconnecting member are able to pivot relative to one another.

FIG. 10 is a cross-section view of a hand tool in according to a second embodiment of the present invention.

FIG. 11 is a cross-section view of a hand tool in according to a third embodiment of the present invention.

FIG. 12 is a cross-section view of a hand tool in according to a fourth embodiment of the present invention.

### DETAILED DESCRIPTION OF THE PREFERRED EMBODIMENTS

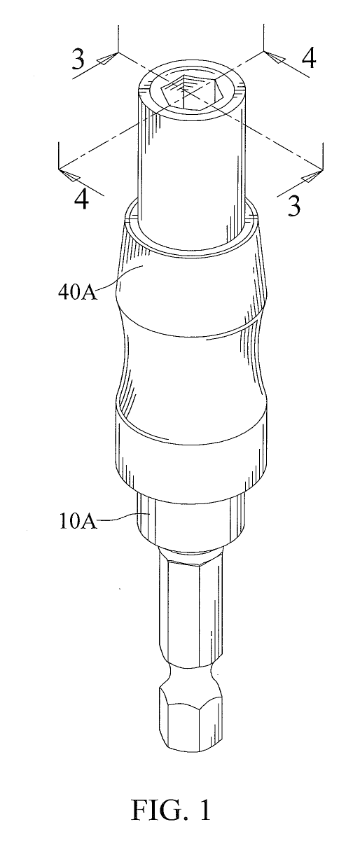

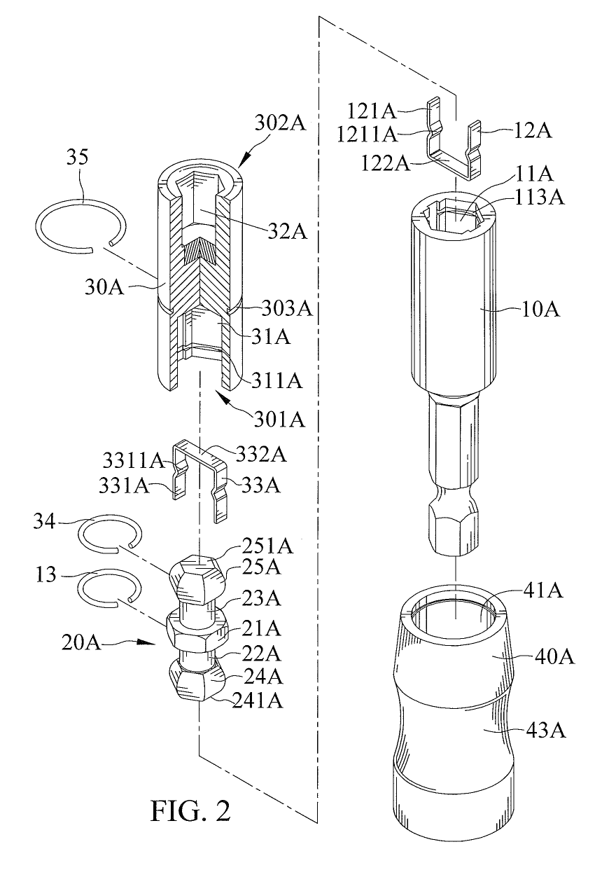

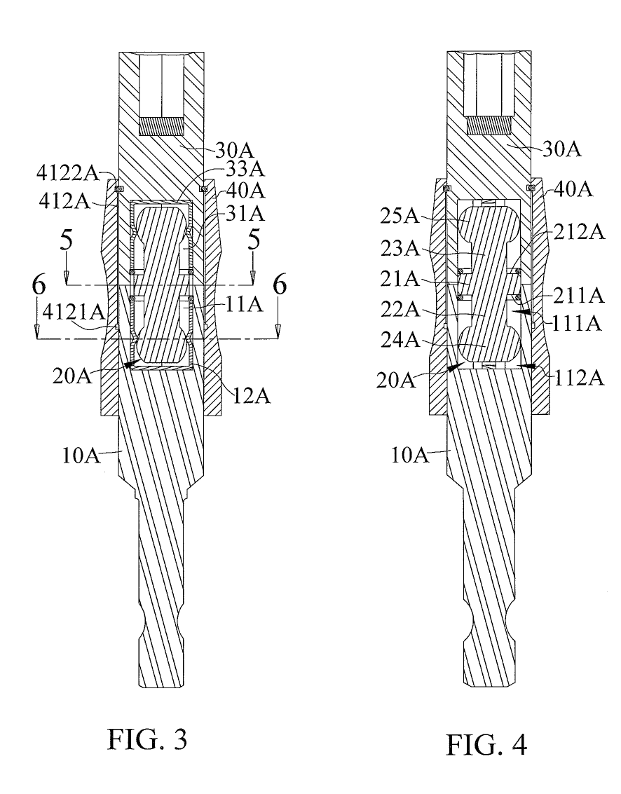

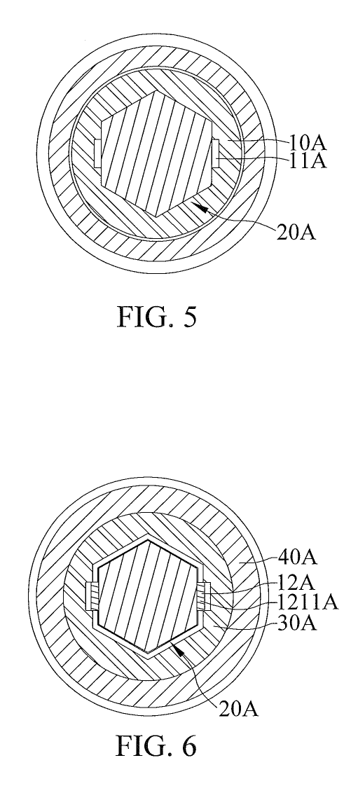

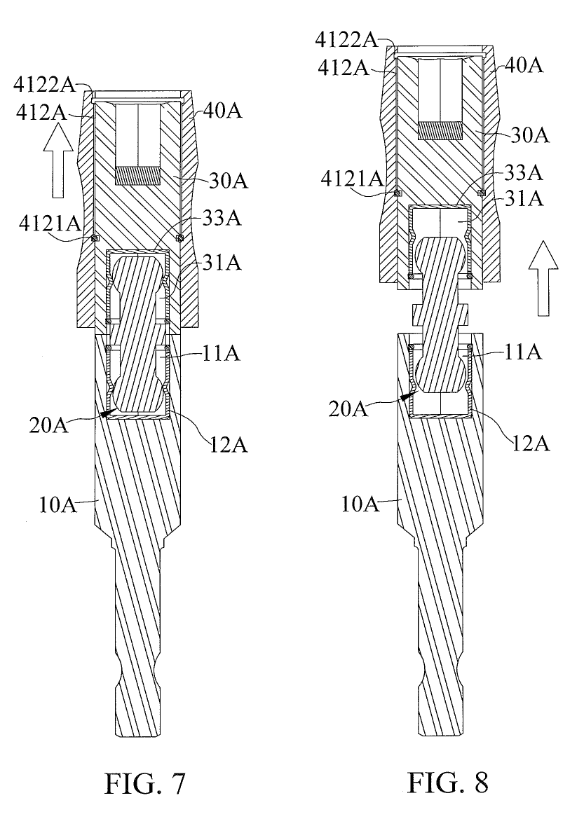

FIGS. 1-9 show a hand tool in accordance with a first embodiment of the present invention including a shaft 10A, a double-ended joint 20A, an interconnecting member 30A, and a sliding sleeve 40A. The shaft 10A includes a first coupled portion 11A in the form of a polygonal hole. Two ends of the first coupled portion 11A respectively define a free end 111A and a closed end 112A. The first coupled portion 11A is in the form of polygonal hole and forms with an annular groove 113A. A positioning element 12A is received in the first coupled portion 11A. The positioning element 12A is an elastic element and has a substantially U shape including two first legs 121A opposite one another and a second leg 122A extended between the two first legs 121A. Each first leg 121A extends axially and includes the outer periphery abutted against the lateral wall of the first coupled portion 11A. The second leg 122A is supported by the closed end 112A. Additionally, each first leg 121A includes a hump 1211A formed on the inner periphery, and the two humps 1211A extend radially towards one another. A blocked element 13 is provided at the annular groove 113A. Further, a center point of each transverse cross-section of the shaft 10A constitutes a central axis A. The double-ended joint 20A differentiates from the double-ended joint 20 in that it includes a connecting portion 21A, first and second neck portions 22A and 23A, and second and third coupled portions 24A and 25A, which are respectively provided at two ends of the double-ended joint 20A. First and second abutted surfaces 211A and 212A are respectively defined on two ends of the connecting portion 21A and are extend outwards with respect to the first and second neck portions 22A and 23A. The cross section of the connecting portion 21A is polygonal and corresponds to the cross section of first coupled portion 11A. The cross sections of the first and second portions 22A and 23A are circular. The second and third coupled portions 24A and 25A are respectively extended from the first and second neck portions 22A and 23A and on opposite sides of the connecting portion 21A. The outer profiles of the second and third coupled portions 24A and 25A both correspond to the inner profile of the first coupled portion 11A. The second and third coupled portions 24A and 25A are in the form of a sphere with polygonal corners. An end of the second and third coupled portions 24A and 25A are coupled to the first and second neck portions 22A and 23A respectively. Other end of the second and third coupled portions 24A and 25A define flat surface 241A and 251A respectively. The double-ended joint 20A is made of metal with magnet or the second and third coupled portions 24A and 25A are both magnetic. A center point of each transverse cross-section of the double-ended joint 20A constitutes a central axis B. The interconnecting member 30A differentiates from the interconnecting member 30 in that it has first and second ends 301A and 302A and forms with a fourth coupled portion 31A and a mounted portion 32A inside thereof respectively. The fourth coupled portion 31A and the mounted portion 32A are both in the form of a polygonal hole. The fourth coupled portion 31A has a shape corresponding to the connecting portion 21A. The positioning element 33A is disposed in the fourth coupled portion 31A and is an elastic element with a shape the same as the positioning element 12A. Likewise, the positioning element 33A includes two first legs 331A opposite one another and a second leg 332A extended between the two first legs 331A. Each first leg 331A extends axially and includes the outer periphery abutted against the lateral wall of the fourth coupled portion 31A. The second leg 122A is supported by a closed end of fourth coupled portion 31A. Additionally, each first leg 331A includes a hump 3311A formed on the inner periphery, and the two humps 1211A extend radially towards one another. An annular groove 311A is formed on the inner wall of an end of the fourth coupled portion 31A. The fourth coupled portion 31A is opposite the mounted portion 32A. The blocked element 34 is provided at the annular groove 311A and is in the form of a C-clip. An annular groove 303A is formed on the outer periphery of the interconnecting member 30A. The retaining element 35 is provided at the annular groove 303A and in the form of a C-clip. A center point of each transverse cross-section of the interconnecting member 30 constitutes a central axis C. The sliding sleeve 40A differentiates from the sliding sleeve 40 in that it includes a through-hole 41A and a limited slider section 412A formed on the inner periphery of the through-hole 41. First and second held portions 4121A and 4122A are respectively defined at two ends of the limited slider section 412A. The retaining element 35 is restricted in the limited slider section 412 and selectively engaged with the first and second held portions 4121A and 4122A. The sleeve 40A surrounds the shaft 10A and the interconnecting element 30A when the retaining element 35 is restricted in the second held portion 4122A. A concaved section 43A is formed on the outer periphery of the sliding sleeve 40A. A user can hold on the concaved section 43 to operate the hand tool.

In this embodiment, the humps 1211A of positioning element 12A abut against the second coupled portion 24A to prevent it from wobbling in the first coupled portion 11A, so the second coupled portion 24A is fixed in the first coupled portion 11A. Likewise, the humps 3311A of positioning element 33A abut against the third coupled portion 25A to prevent it from wobbling in the fourth coupled portion 31A, so the third coupled portion 25A is fixed in the fourth coupled portion 31A.

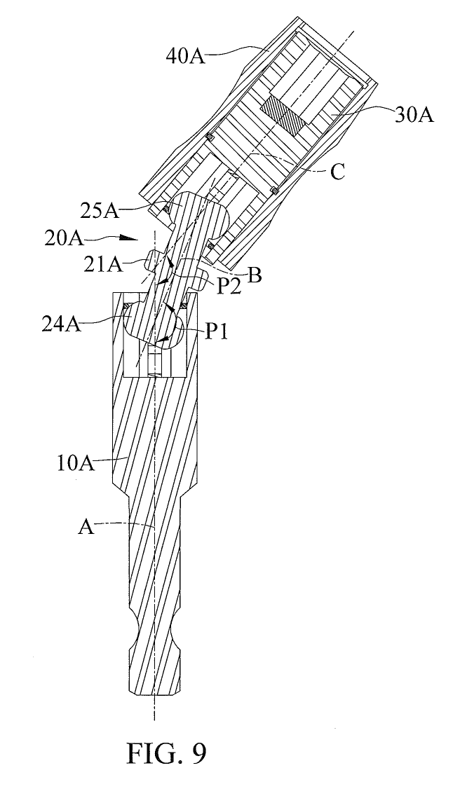

While the double-ended joint 20A is in a first position, the first and second central axes A and B are co-axial, the second coupled portion 24A is fixed to the positioning element 12A of the shaft 10A, and the connecting portion 21A includes the outer periphery partially received in the first coupled portion 11A and partially received in the fourth coupled portion 31A. Since the connecting portion 21A has a shape, which is polygonal and corresponds to the first and fourth coupled portions 11A and 31A, the shaft 10A and the interconnecting member 30A are prevented from a relative rotation, and the hand tool is able to withstand large torque transmission when a large torque is applied to it to drive an object. While the double-ended joint 20A is in a second position, the shaft 10A and the double-ended joint 20A can have various relative tilting positions, and the first and second central axes A and B form a first bent angle P1, i.e., the second central axis B is tilted at the first bent angle P1 with respect to the first central axis A (as shown in FIG. 9). The distal end of the free end 111A of the first coupled portion 11A is in contact with the first neck portion 22A as the first and second central axes A and B intersect at the first bent angle P1. While the interconnecting member 30A is in a first position, the second and third central axes B and C are co-axial and the third coupled portion 25A is fixed to the positioning element 33A of the interconnecting member 30A. While the interconnecting member 30A is in a second position, the double-ended joint 20A and the interconnecting member 30A can have various relative tilting positions. While the double-ended joint 20A and the interconnecting member 30 are both in the second position, the first and third central axes A and C form a second bent angle P2.

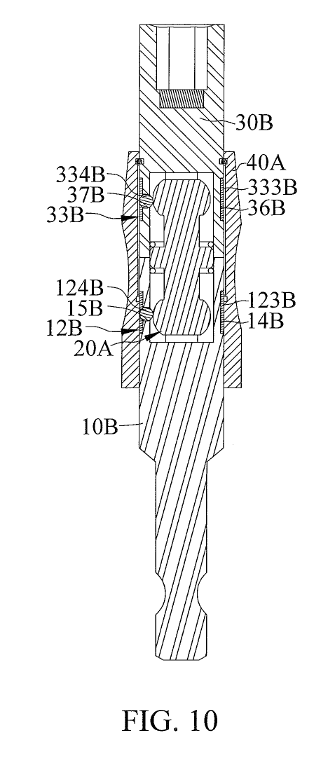

FIG. 10 shows a hand tool in according to a second embodiment of the present invention, which is similar to the first embodiment except that a shaft 10B and an interconnecting member 30B replace the shaft 10A and the interconnecting member 30A, respectively, plus positioning elements 12B and 33B replace the positioning elements 12A and 33A, respectively. The shaft 10B differentiates from the shaft 10A in that it modifies the shaft 10A to further include a recess 14B and a through-bore 15B. The recess 14B is formed on the outer periphery of the shaft 10B and circumferentially extended. The through-bore 15B is extended from the recess 14B and through the inner periphery of the shaft 10B. The interconnecting member 30B differentiates from the interconnecting member 30A in that it modifies the interconnecting member 30A to further include a recess 36B and a through-bore 37B. The recess 36B is formed on the outer periphery of the shaft 10B and circumferentially extended. The through-bore 37B is extended from the recess 36B and through the inner periphery of the interconnecting member 30B. The positioning element 12C includes a ring 123B and a detent 124B and the positioning element 33B includes a ring 333B and a detent 334B, respectively. Each of the detents 124B and 334B is spherical. The ring 123B is mounted in the recess 14B, and the detent 124B is mounted in the through-bore 15B and retained therein by the ring 123B. Likewise, the ring 333B is mounted in the recess 36B, and the detent 334B is mounted in the through-bore 37B and retained therein by the ring 333B.

In this embodiment, the detent 124B abuts against the second coupled portion 24A to prevent it from wobbling in the shaft 10B, so the second coupled portion 24A is fixed in the shaft 10B. Likewise, the detent 334B abuts against the third coupled portion 25A to prevent it from wobbling in the interconnecting member 30B, so the third coupled portion 25A is fixed in the interconnecting member 30B.

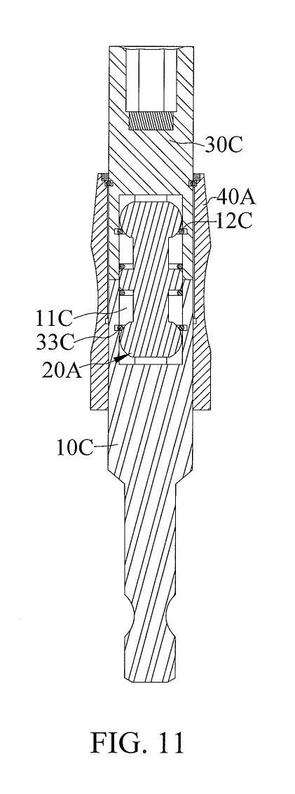

FIG. 11 shows a hand tool in according to a third embodiment of the present invention, which is similar to the first embodiment except that a shaft 10C and an interconnecting member 30C replace the shaft 10A and the interconnecting member 30A, respectively, plus positioning elements 12C and 33C replace the positioning elements 12A and 33A, respectively. The shaft 10C differentiates from the shaft 10A in that it modifies the shaft 10A to further include an annular channel, which is formed on the inner periphery of the shaft 10C and circumferentially extended. The interconnecting member 30C differentiates from the interconnecting member 30A in that it modifies the interconnecting member 30A to further include an annular channel, which is formed on the inner periphery of the interconnecting member 30C and circumferentially extended. Each of the positioning elements 12C and 33C is a ring. The ring is a C-ring. The positioning element 12C is mounted in the annular channel of the shaft 10C and the positioning element 33C is mounted in the annular channel of the interconnecting member 30C respectively.

In this embodiment, the first positioning element 12C abuts against the second coupled portion 24A when second coupled portion 24A is fixed in the shaft 10C, and the second positioning element 33C abuts against the third coupled portion 25A when the third coupled portion 25A is fixed in the interconnecting member 30C.

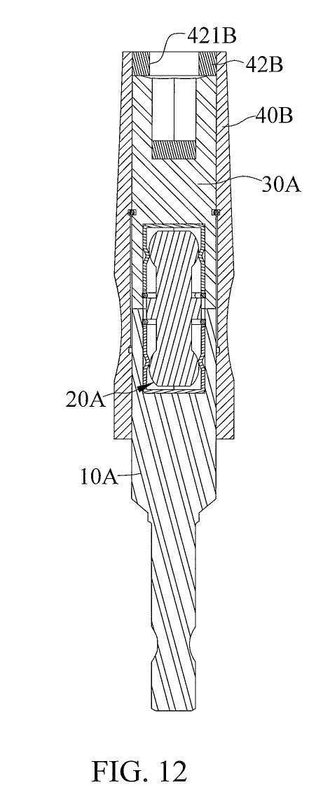

FIG. 12 shows a hand tool in according to a fourth embodiment of the present invention, which is similar to the first embodiment except that a sliding sleeve 40B replaces the sliding sleeve 40A. The sliding sleeve 40B differentiates from the sliding sleeve 40A in that it modifies the sliding sleeve 40A to include an annular magnetic element 42B fitted thereon. The annular magnetic element 42B has a through-hole 421B therethrough, and the sleeve 40A is able to move to a position that the annular magnetic element 42B is abutted against the distal end of the second end 302A of the interconnecting member 30A.

Although not shown, the limited slider section 412A can be modified convex toward inside the sliding sleeve 40A, and same for the sliding sleeve 40B, in addition, the positioning elements 12A, 12B, 12C, 33A, 33B, and 33C can be can be a magnet.

In view of the forgoing, the hand tool can be bent to form various shapes that a user can use it in a tiny space easily. The connecting portion 21A has a shape, which is polygonal and corresponds to the first and fourth coupled portions 11A and 31A, the shaft 10A and the interconnecting member 30A are prevented from a relative rotation, and the hand tool is able to withstand large torque transmission when a large torque is applied to it to drive an object.

While the specific embodiments have been illustrated and described, numerous modifications come to mind without significantly departing from the spirit of invention, and the scope of invention is only limited by the scope of the accompanying claims.

What is claimed is:

1. A hand tool comprising:
a shaft including a first coupled portion;
a first central axis defined through center points of all transverse cross-sections of the shaft;
a double-ended joint including a connecting portion, a second coupled portion on opposite sides of the connecting portion coupled to the first coupled portion and a third coupled portion respectively, with the connecting portion being polygonal in cross section, with the first coupled portion being polygonal in cross section; and
a second central axis defined through center of all transverse cross-sections of the double-ended joint;
wherein the double-ended joint is pivotable with respect to the shaft between first and second positions; wherein the first and second central axes are co-axial and the connecting portion is partially and correspondingly received in the first coupled portion when the double-ended joint is in the first position; wherein the first and second central axes form a first bent angle and the connecting portion is disengaged from the first coupled portion when the double-ended joint is in the second position;
an interconnecting member including a fourth coupled portion coupled to the third coupled portion and a mounted portion; and
a third central axis defined through center of all transverse cross-sections of the interconnecting member;
wherein the interconnecting member is pivotable with respect to the double-ended joint between first and second positions; wherein the second and third central axes are co-axial and the connecting portion is partially and correspondingly received in the fourth coupled portion when the interconnecting member is in the first position; wherein the connecting portion is disengaged from the fourth coupled portion when the interconnecting member is in the second position; wherein the first and third central axes form a second bent angle when the double-ended joint and the interconnecting member are both in the second position.

2. The hand tool as claimed in claim 1 further comprising a sliding sleeve including a through-hole longitudinally piercing through two ends thereof and a limited slider section formed on the inner periphery of the through-hole, with the limited slider section having first and second held portions respectively defined at two ends thereof; wherein the interconnecting member has first and second ends and includes a retaining element provided at the outer periphery thereof between the first and second ends of the interconnecting member and restricted in the limited slider section, wherein the sliding sleeve is slideable with respect to the interconnecting member and the retaining element is selectively engaged with the first and second held portions.

3. The hand tool as claimed in claim 1 wherein each of the second and third coupled portions is in the form of a sphere with polygonal corners.

4. The hand tool as claimed in claim 3 wherein the shaft includes a first positioning element and a first blocked element received in the first coupled portion, with the second coupled portion being fixed and prevented from wobbling in the shaft in the shaft by the positioning element, with the second coupled portion being prevented disengaging from the shaft freely; wherein the interconnecting member includes a second positioning element and a second blocked element received in the fourth coupled portion, with the third coupled portion being fixed and prevented from wobbling in the interconnecting member by the positioning element, with the third coupled portion being prevented disengaging from the interconnecting member freely.

5. The hand tool as claimed in claim 2 wherein the sliding sleeve includes an annular magnetic element fitted thereon; wherein the sleeve is movable to a position in which the annular magnetic element is abutted against a distal end of the second end of the interconnecting member.

6. The hand tool as claimed in claim 4 wherein each of the first and second positioning elements in the shaft and in the interconnecting member is an elastic element and has a U shape and includes two opposite first legs each including a hump, with the first positioning element including the humps abutting against the second coupled portion when the second coupled portion is fixed in the shaft, with the second positioning element including the humps abutting against the third coupled portions when the third coupled portions is fixed in the interconnecting member.

7. The hand tool as claimed in claim 4 wherein the shaft includes a first recess circumferentially extended on the outer periphery thereof and a first through-bore extended from the first recess and through the inner periphery thereof; wherein the interconnecting member includes a second recess circumferentially extended on the outer periphery thereof and a through-bore extended from the and through the inner periphery thereof; wherein each of the first and second positioning elements in the shaft and in the interconnecting member includes a ring and a detent, with the first positioning element includes the ring and detent mounted in the first recess and the first through bore respectively and the detent abutting against the second coupled portion when the second coupled portion is fixed in the shaft, with the second positioning element includes the ring and detent mounted in the second recess and the second through bore respectively and the detent abutting against the third coupled portions when the third coupled portions is fixed in the interconnecting member.

8. The hand tool as claimed in claim 7 wherein the detent of each of the first and second positioning elements is spherical.

9. The hand tool as claimed in claim 4 wherein the shaft includes a first annular channel circumferentially extended on the inner periphery thereof; wherein the interconnecting member includes a second annular channel circumferentially extended on the inner periphery thereof; wherein each of the first and second positioning elements in the shaft and in the interconnecting member is a ring, with the first positioning element abutting against the second coupled portion when second coupled portion is fixed in the shaft, with the second positioning element abutting against the third coupled portion when the third coupled portion is fixed in the interconnecting member.

10. The hand tool as claimed in claim 9 wherein each of the first and second positioning elements is a C-ring.

11. The hand tool as claimed in claim 2 wherein the sleeve is movable to a position surrounding the shaft and the interconnecting element.
